(19) United States
(12) Patent Application Publication
(10) Pub. No.: US 2025/0365599 A1
(43) Pub. Date: Nov. 27, 2025

(54) METHOD FOR WIRELESS COMMUNICATION, USER EQUIPMENT AND BASE STATION

(71) Applicant: GUANGDONG OPPO MOBILE TELECOMMUNICATIONS CORP., LTD., Dongguan (CN)

(72) Inventor: Hao LIN, Neuilly-sur-Seine (FR)

(21) Appl. No.: 19/292,852

(22) Filed: Aug. 6, 2025

Related U.S. Application Data
(63) Continuation of application No. PCT/IB2023/000068, filed on Feb. 10, 2023.

(51) Int. Cl. H04W 24/10; H04L 5/00; H04W 72/231

(52) U.S. Cl. CPC H04W 24/10; H04L 5/0048; H04W 72/231

(57) ABSTRACT

A method for wireless communication is provided. The method for wireless communication is performed by a user equipment (UE). The method includes: performing, by the UE, channel measurement on a first resource and/or a second resource, wherein the first resource and the second resource are respectively associated with different downlink (DL) reference signals (RSs)

### CROSS-REFERENCE TO RELATED APPLICATION

This application is a continuation of International Application No. PCT/IB2023/000068, filed Feb. 10, 2023, the entire disclosure of which is incorporated herein by reference.

### BACKGROUND

### 1. Field of the Disclosure

The present disclosure relates to the field of communication systems, and more particularly, to an apparatus and a method of wireless communication, which can provide a good communication performance and/or high reliability.

### 2. Description of the Related Art

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as long term evolution (LTE) systems, LTE-advanced (LTE-A) systems, or LTE-A pro systems, and fifth generation (5G) systems which may be referred to as new radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

In a third generation partnership project (3GPP) new radio (NR) system, a network may provide a radio resource control (RRC) configuration for an operation, the RRC configuration is normally compatible with the network structure, such as bandwidth size, number of antenna ports, antenna chains, etc. In a future system, operators may intent to reduce a power consumption, therefore, the network structure may need to be adapted/adjusted from time to time, leading, based on legacy system configurations, to RRC reconfiguration or system information updates. This, on the contrary, may increase a network signaling further eating up the gain from the power consumption. Therefore, there is a need for an apparatus (such as a UE and/or a base station) and a method of wireless communication, which can reduce the network power consumption.

### SUMMARY

An object of the present disclosure is to propose a method for wireless communication, a user equipment (UE) and/or a base station (BS).

In some embodiments of the present disclosure, a method for wireless communication is provided. The method is performed by a UE. The method includes: performing, by the UE, channel measurement on a first resource and/or a second resource, wherein the first resource and the second resource are respectively associated with different downlink (DL) reference signals (RSs).

In some embodiments of the present disclosure, a user equipment includes a memory, a transceiver, and a processor coupled to the memory and the transceiver. The processor is configured to: perform channel measurement on a first resource and/or a second resource, wherein the first resource and the second resource are respectively associated with different DL RSs.

In a fourth aspect of the present disclosure, a base station includes a memory, a transceiver, and a processor coupled to the memory and the transceiver. The processor is configured to: configure a DL signal to a UE, wherein the DL signal is configured to trigger a channel measurement on a first resource and/or a second resource, and the first resource and the second resource are respectively associated with different DL RSs.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station (e.g., gNB) of communication in a communication network system according to an embodiment of the present disclosure.

FIG. 2 is a flowchart illustrating a method of wireless communication performed by a user equipment (UE) according to an embodiment of the present disclosure.

FIG. 3 is a flowchart illustrating a method of wireless communication performed by a base station according to an embodiment of the present disclosure.

FIG. 4 is a schematic diagram illustrating an example of a channel measurement according to an embodiment of the present disclosure.

FIG. 5 is a schematic diagram illustrating an example of a resource determination according to an embodiment of the present disclosure.

FIG. 6 is a schematic diagram illustrating an example of a resource determination according to an embodiment of the present disclosure.

FIG. 7 is a schematic diagram illustrating an example of a resource determination according to an embodiment of the present disclosure.

FIG. 8 is a schematic diagram illustrating an example of a resource determination according to an embodiment of the present disclosure.

FIG. 9 is a schematic diagram illustrating an example of a resource determination according to an embodiment of the present disclosure.

FIG. 10 is a block diagram of a wireless communication device according to an embodiment of the present disclosure.

FIG. 11 is a block diagram of a wireless communication device according to an embodiment of the present disclosure.

FIG. 12 is a flowchart illustrating a method of wireless communication performed by a wireless communication device according to an embodiment of the present disclosure.

FIG. 13 is a flowchart illustrating a method of wireless communication performed by a wireless communication device according to an embodiment of the present disclosure.

FIG. 14 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In a third generation partnership project (3GPP) new radio (NR) system, a network may provide a radio resource control (RRC) configuration for an operation, the RRC configuration is normally compatible with the network structure, such as bandwidth size, number of antenna ports, antenna chains, etc. In a future system, operators may intent to reduce a power consumption, therefore, the network structure may need to be adapted/adjusted from time to time, leading, based on legacy system configurations, to RRC reconfiguration or system information updates. This, on the contrary, may increase a network signaling further eating up the gain from the power consumption. In some embodiments of this disclosure, some methods are proposed to remove this issue. Some embodiments of the present disclosure present a method that could efficiently adapt the network configuration.

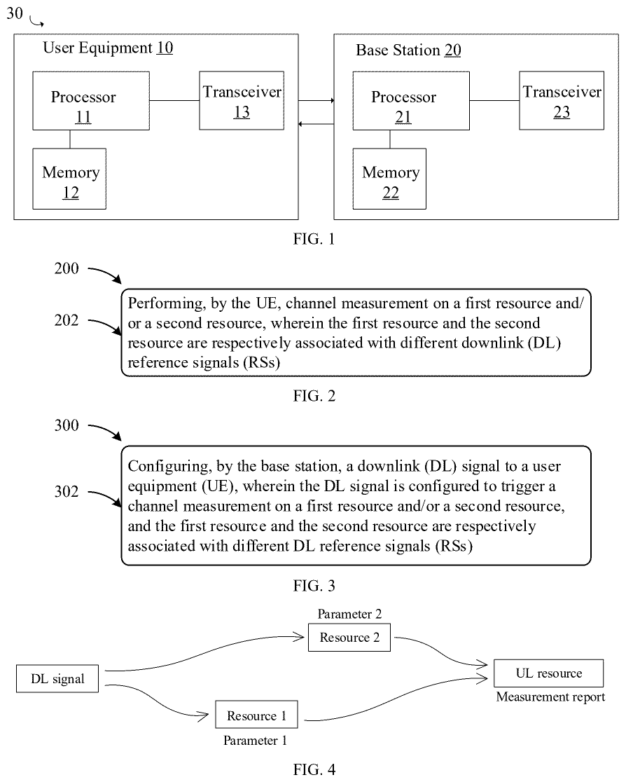

FIG. 1 illustrates that, in some embodiments, one or more user equipments (UEs) 10 and a base station (e.g., gNB) 20 for transmission adjustment in a communication network system 30 (e.g., non-terrestrial network (NTN) or terrestrial network) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to: perform channel measurement on a first resource and/or a second resource, wherein the first resource and the second resource are respectively associated with different downlink (DL) reference signals (RSs). This can adapt a network configuration, reduce a network power consumption, provide a good communication performance, and/or provide a high reliability. The channel measurement may be a channel and/or interference measurement.

In some embodiments, the processor 21 is configured to: configure a downlink (DL) signal to a user equipment (UE), wherein the DL signal is configured to trigger a channel measurement on a first resource and/or a second resource, and the first resource and the second resource are respectively associated with different DL reference signals (RSs). This can adapt a network configuration, reduce a network power consumption, provide a good communication performance, and/or provide a high reliability. The channel measurement may be a channel and/or interference measurement.

FIG. 2 illustrates a method 200 of wireless communication by a UE according to an embodiment of the present disclosure. In some embodiments, the method 200 includes: a block 202, performing, by the UE, channel measurement on a first resource and/or a second resource, wherein the first resource and the second resource are respectively associated with different downlink (DL) reference signals (RSs). This can adapt a network configuration, reduce a network power consumption, provide a good communication performance, and/or provide a high reliability. The channel measurement may be a channel and/or interference measurement.

FIG. 3 illustrates a method 300 of wireless communication by a base station according to an embodiment of the present disclosure. In some embodiments, the method 300 includes: a block 302, configuring, by the base station, a downlink (DL) signal to a user equipment (UE), wherein the DL signal is configured to trigger a channel measurement on a first resource and/or a second resource, and the first resource and the second resource are respectively associated with different DL reference signals (RSs). This can adapt a network configuration, reduce a network power consumption, provide a good communication performance, and/or provide a high reliability. The channel measurement may be a channel and/or interference measurement.

The examples given in this disclosure can be applied for internet of things (IoT) device or narrowband-internet of things (NB-IoT) UE in non-terrestrial network (NTN) systems, but the method is not exclusively restricted to NTN system nor for IoT devices or NB-IoT UE. The examples given in this disclosure can be applied for NR systems, LTE systems, or NB-IoT systems. Further, some examples in the present disclosure can be applied for NB-IoT system, physical downlink control channel (PDCCH) is equivalent to NB-PDCCH (NPDCCH) and physical downlink shared channel (PDSCH) is equivalent to NB-PDSCH (NPDSCH).

### EXAMPLE

A UE receives a DL signal that triggers the UE to perform channel measurement on at least a first resource and/or a second resource, where the first resource contains a first one or more DL reference signals (RSs) and the second resource contains a second one or more DL RSs. The DL signal may be DCI or MAC-CE. The triggering may be an aperiodic CSI triggering. In an example, the triggering may be a semi-persistent CSI triggering. The channel measurement may be a channel and/or interference measurement.

In some examples, as illustrated in FIG. 4, the first one or more DL RSs are associated with a first spatial element; the second one or more DL RSs are associated with a second spatial element. The spatial element (the first spatial element and/or the second spatial element) may include a number of antenna ports and/or a power offset between CSI-RS and PDSCH/DMRS and/or a power offset between SSB and CSI-RS. The UE measures the DL RS in the first resource and/or the second resource and reports the measurement report in an uplink (UL) resource.

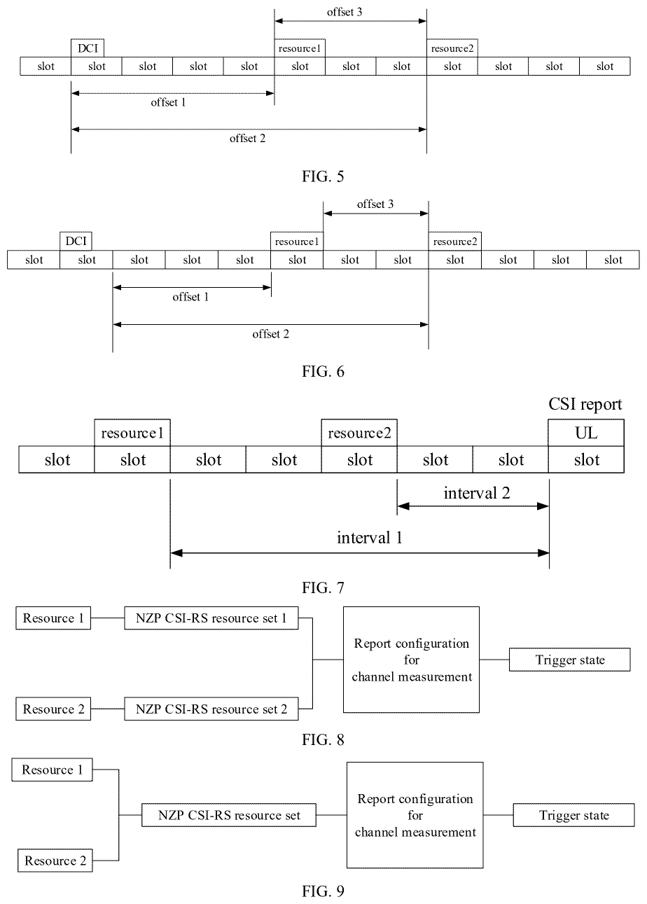

In some examples, the UE determines the first resource in a first slot, where the first slot is a first offset from the slot in which the UE receives the DL signal (such as the DCI) as illustrated in FIG. 5 or FIG. 6. The UE determines the second resource in a second slot, where the second slot is a second offset or a third slot from the slot in which the UE receives the DL signal (such as the DCI). Optionally, the second slot is the second offset or the third offset from the first slot. In some examples, at least two of a value of the first slot, a value of the second slot, and a value of the third slot are same. In some examples, first and/or second and/or third offset values may be same. In some examples, the first offset and/or the second offset and/or the third offset is from a starting or an ending of the slot in which the UE receives the DL signal. In detail, refer to FIG. 5, in some examples, the first offset and/or the second offset is from a starting the slot in which the UE receives the DL signal. The second slot is the third offset from the first slot. In detail, refer to FIG. 6, in some examples, the first offset and/or the second offset is from an ending the slot in which the UE receives the DL signal. The second slot is the third offset from the first slot. A value of the first offset and/or a value of the second offset and/or a value of the third offset is RRC configured or pre-defined. For example, the first offset value and/or the second offset value and/or the second offset value is configured in the IE NZP-CSI-RS-ResourceSet or in IE NZP-CSI-RS-Resource.

In some examples, as illustrated in FIG. 7, the DL signal (such as the DCI) indicates a UL resource for CSI reporting after performing channel measurement on the DL RS in resource 1 and/or resource 2. For UE decides whether to report the measurement result, the UE could follow at least one of the following options:
Option 1: When a first interval is greater than or equal to a processing time, the UE includes the measurement results based on the DL RS in resource 1 in the CSI report, where the first interval is between the last symbol of resource 1 and the first symbol of the UL resource.
Option 2: When a second interval is greater than or equal to a processing time, the UE includes the measurement results based on the DL RS in resource 2 in the CSI report, where the second interval is between the last symbol of resource 2 and the first symbol of the UL resource.
Option 3: When a first interval and a second interval are greater than or equal to a processing time (only when the second interval is greater than or equal to a processing time), the UE includes the measurement results based on both DLRS in resource 1 and resource 2 in the CSI report, or otherwise, the UE does not provide CSI report in the UL transmission.

In some examples, as illustrated in FIG. 8, the first resource is configured to be associated with a first NZP CSI RS resource set and the second resource is configured to be associated with a second NZP CSI RS resource set. The first and the second NZP CSI RS resource sets are associated with a CSI report configuration and the CSI reported configuration is further associated with a CSI trigger state. When the DL signal (such as the DCI) triggers the CSI trigger state, it triggers the first and the second NZP CSI RS resource sets for channel measurement.

In some examples, as illustrated in FIG. 9, the first and the second resources are configured to be associated with a NZP CSI RS resource set. The NZP CSI RS resource set is associated with a CSI report configuration and the CSI reported configuration is further associated with a CSI trigger state. When the DL signal (such as the DCI) triggers the CSI trigger state, it triggers the first resource and/or the second resource for which UE performs channel measurement.

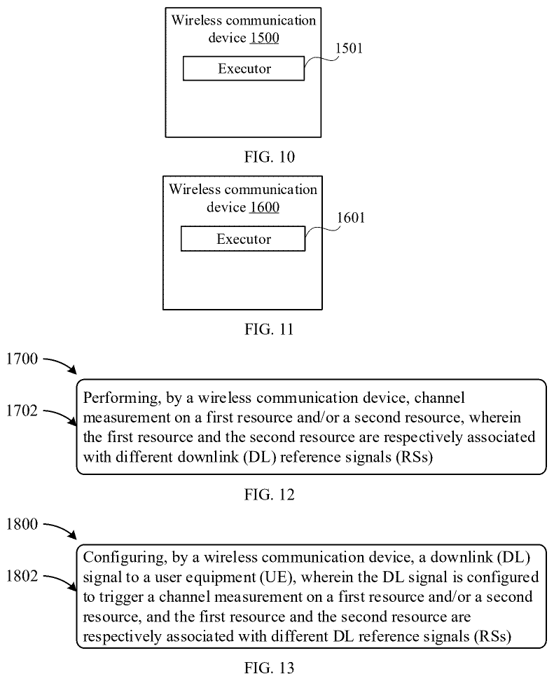

FIG. 10 illustrates a wireless communication device 1500 according to an embodiment of the present disclosure. The wireless communication device 1500 includes an executor 1501 configured to perform channel measurement on a first resource and/or a second resource, wherein the first resource and the second resource are respectively associated with different downlink (DL) reference signals (RSs). This can adapt a network configuration, reduce a network power consumption, provide a good communication performance, and/or provide a high reliability.

FIG. 11 illustrates a wireless communication device 1600 according to an embodiment of the present disclosure. The wireless communication device 1600 includes an executor 1601 configured to configure a downlink (DL) signal to a user equipment (UE), wherein the DL signal is configured to trigger a channel measurement on a first resource and/or a second resource, and the first resource and the second resource are respectively associated with different DL reference signals (RSs). This can adapt a network configuration, reduce a network power consumption, provide a good communication performance, and/or provide a high reliability.

FIG. 12 illustrates a method 1700 of wireless communication by a wireless communication device according to an embodiment of the present disclosure. In some embodiments, the method 1700 includes: a block 1702, performing, by a wireless communication device, channel measurement on a first resource and/or a second resource, wherein the first resource and the second resource are respectively associated with different downlink (DL) reference signals (RSs). This can adapt a network configuration, reduce a network power consumption, provide a good communication performance, and/or provide a high reliability. The wireless communication device may be a UE.

FIG. 13 illustrates a method 1800 of wireless communication by a wireless communication device according to an embodiment of the present disclosure. In some embodiments, the method 1800 includes: a block 1802, configuring, by a wireless communication device, a downlink (DL) signal to a user equipment (UE), wherein the DL signal is configured to trigger a channel measurement on a first resource and/or a second resource, and the first resource and the second resource are respectively associated with different DL reference signals (RSs). This can adapt a network configuration, reduce a network power consumption, provide a good communication performance, and/or provide a high reliability. The wireless communication device may be a base station.

In some embodiments, the method further comprises reporting, by the UE, a measurement report in an uplink (UL) resource. In some embodiments, the method further comprising receiving, by the UE, a downlink signal from a base station, wherein the DL signal is configured to trigger the UE to perform channel measurement on the first resource and/or the second resource, and/or the DL signal is configured to indicate the UL resource for the measurement report. In some embodiments, the DL signal comprises a downlink control information (DCI) and/or a medium access control-control element (MAC-CE).

In some embodiments, the DL signal is configured to trigger the UE to perform channel measurement on the first resource and/or the second resource using an aperiodic channel state information (CSI) triggering and/or a semi-persistent CSI triggering. In some embodiments, the first resource comprises a first one or more DL RSs and the second resource comprises a second one or more DL RSs. In some embodiments, the first one or more DL RSs are associated with a first parameter, and the second one or more DL RSs are associated with a second parameter. In some embodiments, the first parameter comprises a first spatial element, and the second parameter comprises a second spatial element. In some embodiments, the first spatial element comprises a first number of antenna ports and/or a first power offset, and the second spatial element comprises a second number of antenna ports and/or a second power offset. In some embodiments, the first power offset and/or the second power offset comprises a power offset between a CSI-RS and a physical downlink shared channel (PDSCH), a power offset between the CSI-RS and a demodulation RS (DMRS), and/or a power offset between a synchronization signal block (SSB) and the CSI-RS.

In some embodiments, the UE is configured to determine the first resource in a first slot, where the first slot comprises a first offset from a slot in which the UE receives the DL signal. In some embodiments, the UE is configured to determine the second resource in a second slot, where the second slot comprises a second offset from a slot in which the UE receives the DL signal, and/or the second slot comprises a third offset from the first slot.

In some embodiments, at least two of a value of the first slot, a value of the second slot, and a value of the third slot are same. In some embodiments, first and/or second and/or third offset values may be same. In some embodiments, the first offset and/or the second offset and/or the third offset is from a starting or an ending of the slot in which the UE receives the DL signal. In some embodiments, a value of the first offset and/or a value of the second offset and/or a value of the third offset is radio resource control (RRC) configured or pre-defined. In some embodiments, a value of the first offset and/or a value of the second offset and/or a value of the third offset is configured in an IE NZP-CSI-RS-ResourceSet or in an IE NZP-CSI-RS-Resource.

In some embodiments, when a first interval is greater than or equal to a processing time, the UE comprises a measurement result based on the first one or more DL RSs in the first resource in the measurement report, where the first interval is between a last symbol of the first resource and a first symbol of the UL resource. In some embodiments, when a second interval is greater than or equal to a processing time, the UE comprises a measurement result based on the second one or more DL RSs in the second resource in the measurement report, where the second interval is between a last symbol of the second resource and a first symbol of the UL resource. In some embodiments, when the first interval and the second interval are greater than or equal to the processing time, the UE comprises the measurement result based on the first one or more DL RSs in the first resource and the second one or more DL RSs in the second resource in the measurement report, or otherwise, the UE does not provide the measurement report in an UL transmission.

In some embodiments, the first resource is configured to be associated with a first non-zero power (NZP) CSI RS resource set and the second resource is configured to be associated with a second NZP CSI RS resource set. In some embodiments, the first resource and the second resource are configured to be associated with a same NZP CSI RS resource set. In some embodiments, the first NZP CSI RS resource set and the second NZP CSI RS resource set are associated with a CSI report configuration, and/or the NZP CSI RS resource set is associated with the CSI report configuration. In some embodiments, the CSI reported configuration is associated with a CSI trigger state. In some embodiments, when the DL signal triggers the CSI trigger state, the CSI trigger state triggers the first NZP CSI RS resource set and the second NZP CSI RS resource set for channel measurement, and/or the CSI trigger state triggers the NZP CSI RS resource set for channel measurement.

Commercial interests for some embodiments are as follows. 1. Reducing a network power consumption. 2. Providing a good communication performance. 3. Providing a high reliability. 4. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in 5G NR licensed and non-licensed or shared spectrum communications. Some embodiments of the present disclosure propose technical mechanisms.

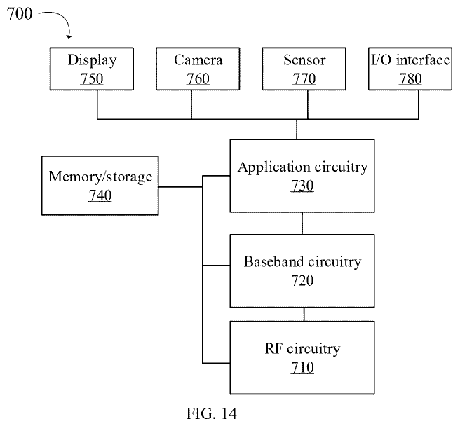

FIG. 14 is a block diagram of an example system 700 for wireless communication according to an embodiment of the present disclosure. Embodiments described herein may be implemented into the system using any suitably configured hardware and/or software. FIG. 14 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method for wireless communication, performed by a user equipment (UE), the method comprising:
performing, by the UE, channel measurement on a first resource and/or a second resource, wherein the first resource and the second resource are respectively associated with different downlink (DL) reference signals (RSs).

2. The method according to claim 1, further comprising at least one of:
reporting, by the UE, a measurement report in an uplink (UL) resource; or
receiving, by the UE, a downlink signal from a base station, wherein the DL signal is configured to trigger the UE to perform channel measurement on the first resource and/or the second resource, and/or the DL signal is configured to indicate the UL resource for the measurement report.

3. The method according to claim 2, wherein the DL signal comprises a downlink control information (DCI) and/or a medium access control-control element (MAC-CE).

4. The method according to claim 2, wherein the DL signal is configured to trigger the UE to perform channel measurement on the first resource and/or the second resource using an aperiodic channel state information (CSI) triggering and/or a semi-persistent CSI triggering.

5. The method according to claim 1, wherein the first resource comprises a first one or more DL RSs and the second resource comprises a second one or more DL RSs;
wherein the first one or more DL RSs are associated with a first parameter, and the second one or more DL RSs are associated with a second parameter;
wherein the first parameter comprises a first spatial element, and the second parameter comprises a second spatial element.

6. The method according to claim 5, wherein the first spatial element comprises a first number of antenna ports and/or a first power offset, and the second spatial element comprises a second number of antenna ports and/or a second power offset;
wherein the first power offset and/or the second power offset comprises a power offset between a CSI-RS and a physical downlink shared channel (PDSCH), a power offset between the CSI-RS and a demodulation RS (DMRS), and/or a power offset between a synchronization signal block (SSB) and the CSI-RS.

7. The method according to claim 2, wherein the UE is configured to determine the first resource in a first slot, where the first slot comprises a first offset from a slot in which the UE receives the DL signal.

8. The method according to claim 4, wherein when a first interval is greater than or equal to a processing time, the UE comprises a measurement result based on a first one or more DL RSs in the first resource in the measurement report, where the first interval is between a last symbol of the first resource and a first symbol of the UL resource.

9. The method according to claim 4, wherein when a second interval is greater than or equal to a processing time, the UE comprises a measurement result based on a second one or more DL RSs in the second resource in the measurement report, where the second interval is between a last symbol of the second resource and a first symbol of the UL resource.

10. The method according to claim 8, wherein when the first interval and a second interval are greater than or equal to the processing time, the UE comprises the measurement result based on the first one or more DL RSs in the first resource and the second one or more DL RSs in the second resource in the measurement report, or otherwise, the UE does not provide the measurement report in an UL transmission.

11. A user equipment (UE), comprising:
a memory;
a transceiver; and
a processor coupled to the memory and the transceiver;
wherein the UE is configured to perform channel measurement on a first resource and/or a second resource, wherein the first resource and the second resource are respectively associated with different downlink (DL) reference signals (RSs).

12. The UE according to claim 11, wherein the UE is configured to perform at least one of:
reporting a measurement report in an uplink (UL) resource; or
receiving a downlink signal from a base station, wherein the DL signal is configured to trigger the UE to perform channel measurement on the first resource and/or the second resource, and/or the DL signal is configured to indicate the UL resource for the measurement report.

13. The UE according to claim 12, wherein the UE is configured to determine the second resource in a second slot, where the second slot comprises a second offset from a slot in which the UE receives the DL signal, and/or the second slot comprises a third offset from a first slot;
wherein at least two of a value of the first slot, a value of the second slot, and a value of the third slot are same.

14. The UE according to claim 13, wherein the first offset and/or the second offset and/or the third offset is from a starting or an ending of the slot in which the UE receives the DL signal.

15. The UE according to claim 13, wherein a value of the first offset and/or a value of the second offset and/or a value of the third offset is radio resource control (RRC) configured or pre-defined.

16. The UE according to claim 13, wherein a value of the first offset and/or a value of the second offset and/or a value of the third offset is configured in an IE NZP-CSI-RS-ResourceSet or in an IE NZP-CSI-RS-Resource.

17. The UE according to claim 12, wherein the first resource is configured to be associated with a first non-zero power (NZP) CSI RS resource set and the second resource is configured to be associated with a second NZP CSI RS resource set; or
the first resource and the second resource are configured to be associated with a same NZP CSI RS resource set.

18. The UE according to claim 17, wherein the first NZP CSI RS resource set and the second NZP CSI RS resource set are associated with a CSI report configuration, and/or the NZP CSI RS resource set is associated with the CSI report configuration;
wherein the CSI reported configuration is associated with a CSI trigger state.

19. The UE according to claim 18, wherein when the DL signal triggers the CSI trigger state, the CSI trigger state triggers the first NZP CSI RS resource set and the second NZP CSI RS resource set for channel measurement, and/or the CSI trigger state triggers the NZP CSI RS resource set for channel measurement.

20. A base station, comprising:
a memory;
a transceiver; and
a processor coupled to the memory and the transceiver;
wherein the base station is configured to configure a downlink (DL) signal to a user equipment (UE), wherein the DL signal is configured to trigger a channel measurement on a first resource and/or a second resource, and the first resource and the second resource are respectively associated with different DL reference signals (RSs).
